(19) United States
(12) Patent Application Publication
(10) Pub. No.: US 2025/0117457 A1
(43) Pub. Date: Apr. 10, 2025

(54) SYSTEMS AND METHODS FOR SECURING CONTENT

(71) Applicant: Capital One Services, LLC, McLean, VA (US)

(72) Inventors: Shahalam BAIG, Rochester, NY (US); Matthew HUNSBERGER, Hoboken, NJ (US); Shasanka BHANDARI, McLean, VA (US); Jackson WESTWOOD, New York, NY (US); Hyunwoo KANG, New York, NY (US)

(73) Assignee: Capital One Services, LLC, McLean, VA (US)

(21) Appl. No.: 18/905,181

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10; G06F 16/957; G06F 21/62

(52) U.S. Cl. CPC G06F 21/1066; G06F 16/9577; G06F 21/6245

(57) ABSTRACT

A method may include receiving, using a computing device, a document including a first page. The method may include transmitting, using the computing device, the document to an application server. The method may include receiving, using the computing device, a first video from the application server. The first video may be associated with a digital rights management technology and include a single image frame. The single image frame may represent the first page of the document. The method may include forming, using a browser module of the computing device, a first Hypertext Markup Language (HTML) element including the first video. The method may also include outputting, using an operating system of the computing device, the first video of the first HTML element to a display screen associated with the computing device.

### CROSS-REFERENCE TO RELATED APPLICATION(S)

This application claims the benefit of pending U.S. Provisional Patent Application No. 63/587,891, filed on Oct. 4, 2023, and claims the benefit of pending U.S. Provisional Patent Application No. 63/665,485, filed on Jun. 28, 2024, and claims the benefit of pending U.S. Provisional Patent Application No. 63/683,063, filed Aug. 14, 2024, each of which is incorporated herein by reference in its entirety.

### TECHNICAL FIELD

Various embodiments of this disclosure relate generally to techniques for securing content, and more particularly to systems and methods for securing content of an electronic document (also referred to herein as a “document”), such as a text document, an image document, a presentation, a spreadsheet, a Portable Document Format (“PDF”) file, a multimedia file, or the like.

### BACKGROUND

Organizations such as banks and healthcare providers seek to protect sensitive information (e.g., confidential information, personally identifiable information, financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, the target may be a customer of a business who uses a display screen (also referred to herein as a “screen”) of a computing device to view an account number on the business' website. In some aspects, the business' website may be represented by an HTML page temporarily stored on the customer's computing device, and the account number may be programmed (or written) in HTML, within the HTML page. A social engineer using another computing device may persuade the customer to reveal the account number to the social engineer. More specifically, the social engineer may convince the customer to share the customer's screen displaying the account number with the social engineer, using a screensharing or remote desktop application. In addition or in the alternative, the social engineer may convince the customer to take a screenshot of the customer's screen displaying the account number, using a screenshotting application, and to then transmit the screenshot to the social engineer.

To guard against such social engineering, the business may employ a technology that limits the use of digital content that is programmed (or written) in HTML, within the HTML page of the business' website. However, the business may also wish to protect digital content that is not written in HTML, and that may or may not be included in the HTML page of the business' website, from being screenshared or screenshotted with the social engineer.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for securing content of a document (e.g., text document, an image document, a presentation, a spreadsheet, a PDF file, a multimedia file, or the like) are disclosed. Each of the examples disclosed herein may include one or more features described in connection with any of the other disclosed examples.

In one aspect, an exemplary embodiment of a method may include receiving, using a computing device, a document including a first page. The method may include transmitting, using the computing device, the document to an application server. The method may include receiving, using the computing device, a first video from the application server. The first video may be associated with a digital rights management technology (“DRM”) and include a single image frame. The single image frame may represent the first page of the document. The method may include forming, using a browser module of the computing device, a first Hypertext Markup Language (HTML) element including the first video. The method may also include outputting, using an operating system of the computing device, the first video of the first HTML element to a display screen associated with the computing device.

In a further aspect, an exemplary embodiment of a system may include at least one processor and at least one memory having programming instructions stored thereon, which, when executed by the at least one processor, cause the system to perform operations. The operations may include receiving, using a computing device, a document including a first page. The operations may include transmitting, using the computing device, the document to an application server. The operations may include receiving, using the computing device, a first video from the application server. The first video may be associated with a digital rights management technology and include a single image frame. The single image frame may represent the first page of the document. The operations may include forming, using the computing device, an HTML element including the first video. The operations may also include outputting, using the computing device, the first video of the HTML element to a display screen associated with the computing device.

In another aspect, an exemplary embodiment of a method may include receiving, using a computing device, a document including a page. The page may include sensitive information. The method may include transmitting, using the computing device, the document to an application server. The method may include receiving, using the computing device, a video from the application server. The video may be associated with a digital rights management technology and include a single image frame. The single image frame may represent the page of the document. The method may include forming, using a browser module of the computing device, an HTML element including the video. The method may also include outputting, using an operating system of the computing device, the video of the HTML element to a display screen associated with the computing device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2 depicts a flowchart of an example method, according to one or more embodiments.

FIG. 3 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the term “content element” may represent data such as text data (e.g., letters, numbers, symbols, metadata, or alt text), image data (e.g., an image, a graphic, a sequence of image frames, or a video), or audio data (e.g., a sequence of audio frames). Further, in some embodiments, a content element may be dynamic (e.g., configured to change over time), such as an animated graphic or a video advertisement. Further, in some embodiments, a content element may be interactive (e.g., configured to respond to an input from a user of a computing device), such as a button, a toggle switch, a field configured to display text, a link (e.g., a hyperlink), an icon that may be selected to launch an application, text that may be highlighted or selected (e.g., using a cursor), or one or more images that may be highlighted or selected (e.g., using a cursor). In some aspects, a content element may include one or more content elements. Further, a content element may represent data included in, or referred by, an HTML element of an HTML page corresponding to (or representing) a webpage.

As used herein, the term “HTML page” may refer to a file that includes HTML, and that defines the structure and content of a webpage or website. An HTML element may represent a component of an HTML page, and may include, for example, a start tag, an end tag, a content element, or a reference to a content element (e.g., a link, hyperlink, address, or path to a content element). In some embodiments, an HTML element may include one or more HTML elements (e.g., nested HTML elements).

As used herein, the term “electronic document,” “document,” or “content object” may refer to an electronic file (also referred to herein as a “file”) that includes text data, image data, audio data (e.g., a sequence of audio frames), video data (e.g., a sequence of image frames or video frames), or other data, and that is not programmed (or written) in HTML. A document may represent, for example, a text document (e.g., a Microsoft Word document, a plain text file, or the like), a spreadsheet (e.g., a Microsoft Excel file, a comma-separated values file, or the like), a presentation, slides, or slide deck (e.g., a Microsoft PowerPoint file or the like), a PDF file, an image document (e.g., a Joint Photographic Experts Group (“JPEG”) file, a Portable Network Graphics (“PNG”) file, a Graphics Interchange Format (“GIF”) file, a Scalable Vector Graphics (“SVG”) file, or the like), a multimedia file (e.g., a file that includes text data and one or more of image data, audio data, or video data), or the like. In some embodiments, a document may include one or more content elements (or represent a single content element).

As used herein, the term “sensitive information” may refer to data that is intended for, or restricted to the use of, one or more users or entities. Sensitive information may represent data that is personal, private, confidential, privileged, secret, classified, or in need of protection. Examples of sensitive information may include financial data such as account numbers, credit card account numbers, checking account numbers, virtual card numbers, savings account numbers, account balances, credit card account balances, checking account balances, savings account balances, financial statements, bills, or invoices; personally identifiable information such as a name, address, phone number, social security number, or driver's license number; medical information such as a patient's medical history, a doctor's summary or diagnosis, or medical test results; academic information such as a student's grades or transcript; business information such as trade secrets, proprietary information, alpha product releases, or business strategy information; governmental information such as classified or secret information related to national security or defense; or data that is copyrighted, etc.

As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11®, an application accessed using a Print Screen key of a keyboard or keypad, or the like).

As used herein, the terms “image frame that is transparent” and “transparent image frame” refer to an image frame of a video, where the image frame is clear (e.g., see-through or invisible, from the perspective of a user viewing the image frame on a display screen), and does not depict or represent any sensitive information.

As used herein, a “machine learning model” generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as a neural network(s), convolutional neural network(s), regional convolutional neural network(s), mask regional convolutional neural network(s), deformable detection transformer(s), linear regression, logistical regression, random forest, gradient boosted machine (GBM), deep learning, or a deep neural network. Supervised or unsupervised training may be employed. For example, supervised learning may include providing training data and labels corresponding to the training data, e.g., as ground truth. Unsupervised approaches may include clustering, classification or the like. Any suitable type of training may be used, e.g., stochastic, gradient boosted, random seeded, recursive, epoch or batch-based, etc.

In the following description, embodiments will be described with reference to the accompanying drawings. As will be discussed in more detail below, various embodiments, methods, and systems for securing content of a document (e.g., text document, an image document, a presentation, a spreadsheet, a PDF file, a multimedia file, or the like) are described.

In a first exemplary use case, a client of a law firm may use a computing device, such as a laptop, to obtain legal information. More specifically, the client may use a browser presented on a display screen of the laptop to load a webpage that is associated with the law firm, and on which the client anticipates viewing a PDF document representing a one-page contract. In some embodiments, prior to the webpage being loaded, the client may be authenticated by the laptop (e.g., during or in association with authentication session) as a security measure. In some aspects, the PDF document may represent (or include) sensitive information. Sensitive information may refer to data that is intended for, or restricted to the use of, one or more users or entities (e.g., the client and the law firm).

As the webpage is loaded, the laptop may determine that the PDF document represents (or includes) sensitive information. Consequently, the laptop may transmit the PDF document to an application server associated with the law firm. The laptop may further receive, from the application server, a video that includes a single image frame representing the entire one-page contract (or the PDF document). In some aspects, the video may be associated with (e.g., protected by) a DRM technology. Further, the video may be configured to play the single image frame in a loop such that, during the playing, the single image frame may appear as a static image (rather than a video) on the display screen. In some aspects, the video may represent a single-frame looped video. Upon receiving the video, the laptop may use a browser to form an HTML element that includes the video, where the HTML element may be included in an HTML page of the webpage associated with the law firm. The laptop may further output, using an operating system, the video of the HTML element to the display screen.

In some aspects, because the video is protected by the DRM technology, the video may be configured to play on the display screen so long as the display screen is not being screenshared or screenshotted (e.g., using a screensharing application or a screenshotting application, respectively). Consequently, the single image frame depicting the contract (or the PDF document) cannot be screenshared with, or screenshotted for, a social engineer or potential social engineer. By contrast, if the client begins to screenshare, or take a screenshot of, the display screen on which the video is presented, the video may stop playing the single image frame and optionally disappear from the display screen.

Accordingly, embodiments presented herein may use a DRM technology to protect documents that are not programmed (or written) in HTML, and that may include sensitive information (or non-sensitive information), from being shared with social engineers or potential social engineers. Further, relative to documents that are not protected by a DRM technology, the DRM-protected documents (or DRM-protected videos representing documents) described herein may be more cumbersome for a social engineer or potential social engineer to download or access. In addition, if a social engineer or other bad actor injects code into an authentication session that is associated with a DRM-protected video, and subsequently steals (or rips) the DRM-protected video, the injected code may serve as an identifier or indicator that the DRM-protected video was stolen.

While the use case above involves a webpage, a PDF document, and sensitive information, it should be understood that techniques according to this disclosure may be adapted to any suitable type of program (e.g., a website, portal, application, browser extension, plugin, etc.), document (e.g., a text document, an image document, a presentation, a spreadsheet, a multimedia file, or the like), and data (e.g., sensitive information, non-sensitive information, text data, image data, audio data, etc.), respectively. It should also be understood that the example above is illustrative only. The techniques and technologies of this disclosure may be adapted to any suitable activity.

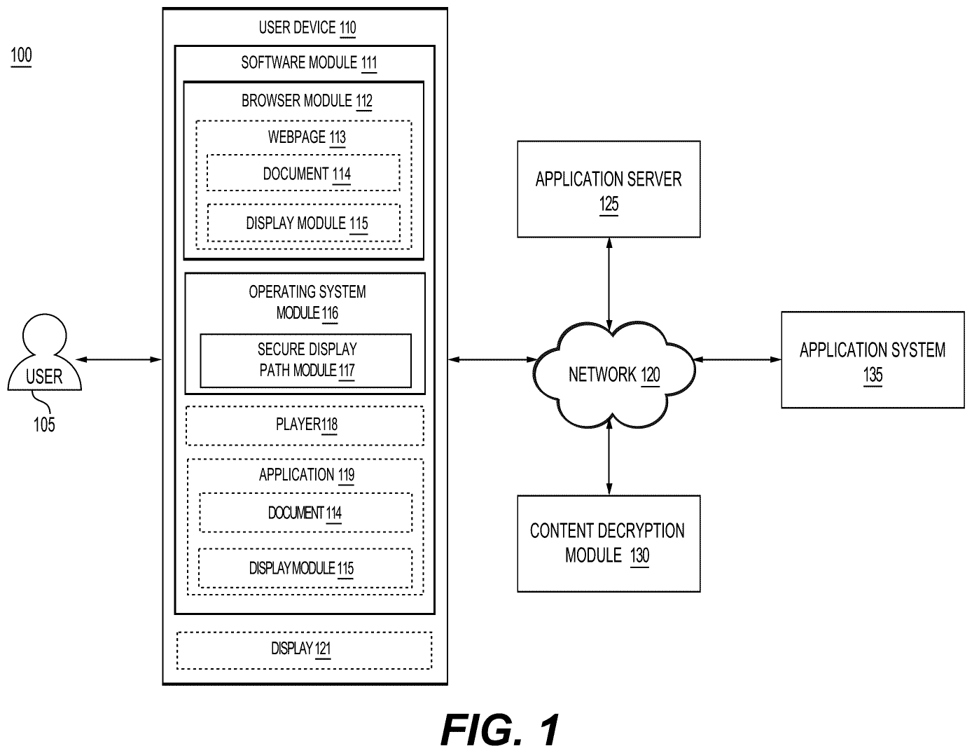

FIG. 1 depicts an example environment 100 that may be utilized with techniques presented herein. In some aspects, the environment 100 may be an embodiment of (i) the environment 100 described in U.S. Provisional Application 63/587,891, filed on Oct. 4, 2023, (ii) the environment 100 described in U.S. Provisional Application 63/665,485, filed on Jun. 28, 2024, or (iii) the environment 100 described in U.S. Provisional Patent Application No. 63/683,063, filed Aug. 14, 2024 where each of these U.S. provisional applications is incorporated by reference herein in its entirety. As shown in FIG. 1, the environment 100 may include a user device 110, a network 120 (e.g., an electronic network), an application server 125, an application system 135, and a content decryption module 130 (also referred to herein as the “CDM 130”). In some aspects, the user device 110, the application server 125, the application system 135, and the CDM 130 may communicate with one another in any arrangement across the network 120. The user device 110 may be associated with a user 105. In some embodiments, the user 105 may be a customer or employee of, or contractor for, a company, business, or organization (e.g., a bank, a law firm, a hospital, a university, etc.), or the like. Further, in some embodiments, the company, business, or organization may be associated with (e.g., own, rent, or control) the user device 110. In some other embodiments, the user 105 may own, rent, or control the user device 110. Further, in some embodiments, the user 105 may be an authorized user of the user device 110 and a portal (e.g., a webpage, a website, a web application, a platform, an electronic application, program, a plugin, a browser extension, or the like) accessed using the user device 110.

The user device 110 may be configured to enable the user 105 to access or interact with the network 120, the application server 125, the application system 135, and the CDM 130, in the environment 100. For example, the user device 110 may be a computer system such as a desktop computer, a laptop, a workstation, a mobile device, a tablet, etc. In some embodiments, the user device 110 may include one or more software modules, which may represent electronic application(s) such as a program, a platform, a plugin, or a browser extension, installed on a memory of the user device 110. For example, as shown in FIG. 1, the user device 110 may include a software module 111 that may represent (or include), for example, a browser module 112, an operating system module 116, and optionally one or more of a player 118 and an application 119.

The player 118 may represent a video player configured to play back one or more videos, or present image frames (or video frames) of one or more videos on a display screen. In some embodiments, the player 118 may be included in the browser module 112 or the operating system module 116 (not shown in FIG. 1). In some other embodiments, the player 118 may represent hardware included in the user device 110 (not shown in FIG. 1). In some embodiments, the player 118 may represent an interactive video player, which is a video player configured to play back a video, where a user (e.g., the user 105) may interact with the video (e.g., by selecting a button presented in the video) during the playback on a display screen.

The application 119 may represent one or more applications or programs configured to perform operations. For example, the one or more applications may be configured to protect at least a portion of one or more documents (or the entirety of one or more documents) using a DRM technology. The one or more applications may also be configured to output one or more documents (which may or may not be protected using a DRM technology) to a display screen.

As shown in FIG. 1, the user device 110 may also optionally include a display 121, which may represent a display screen configured to display or present data (optionally using at least the player 118). More specifically, the display 121 may be configured to display or present data that the display 121 receives from the browser module 112, the operating system module 116, or the application 119.

The browser module 112 may include one or more browsers (e.g., web browsers or applications for accessing and viewing content on the internet, the World Wide Web, a cloud platform, etc.). In some embodiments, the browser module 112 may be configured to communicate with the operating system module 116, the player 118, the application 119, the display 121, the network 120, and the application server 125, the application system 135, and the CDM 130, via the network 120. For example, in response to the user 105 inputting a web address (or uniform resource locator) to the browser module 112 (e.g., using the display 121 or a keyboard or other input/output device associated with the user device 110), the browser module 112 may be configured to transmit a request for a webpage (or website, portal, platform, etc.) associated with the web address, to the application server 125 or the application system 135, via the network 120. The browser module 112 may also be configured to receive the webpage (e.g., an HTML page corresponding to or representing the webpage) from the application server 125 or the application system 135, via the network 120.

In some aspects, the received webpage (or website, web application, portal, platform, a platform interface, application, program, browser extension, plugin, or the like) may be referred to herein as the webpage 113, as shown in FIG. 1. In some embodiments, one or more of the webpage 113, a webpage associated with the webpage 113, the browser module 112, the application server 125, or the application system 135, may be configured to authenticate a user (e.g., the user 105) viewing (or accessing) the webpage 113 using, for example, Single Sign-On (“SSO”), multi-factor authentication (“MFA”), or the like. In some embodiments, the webpage 113 may include or be associated with a document 114 (or multiple documents 114). For example, in some embodiments, the webpage 113 may be configured to upload, retrieve, or receive the document 114 from the user device 110 (e.g., using a web application associated with the webpage 113, or file manager associated with the user device 110). The webpage 113 may also be configured to download, retrieve or receive the document 114 from the network 120 (e.g., using a web application associated with the webpage 113). In some embodiments, the webpage 113 may be integrated with, or configured to access or communicate with (e.g., using a web application), a cloud storage service such as Google Drive, Dropbox®, Microsoft OneDrive®, iCloud®, Amazon S3, or the like. Further, in some embodiments, the webpage 113 may represent a website of a cloud storage service.

In some aspects, the document 114 (e.g., a content object) may represent an electronic document or file that includes text data, image data, audio data (e.g., a sequence of audio frames), video data (e.g., a sequence of image frames or video frames), or other data, and that is not programmed (or written) using HTML. For example, the document 114 may represent a text document (e.g., a Microsoft Word document, a plain text file, or the like), a spreadsheet (e.g., a Microsoft Excel file, a comma-separated values file, or the like), a presentation, slides, or slide deck (e.g., a Microsoft PowerPoint file or the like), a PDF file, an image document (e.g., a Joint Photographic Experts Group (“JPEG”) file, a Portable Network Graphics (“PNG”) file, a Graphics Interchange Format (“GIF”) file, a Scalable Vector Graphics (“SVG”) file, or the like), or a multimedia file (e.g., a file that includes text data and one or more of image data, audio data, or video data, or the like).

Further, in some aspects, the document 114 may include one or more content elements (or represent a single content element). As used herein, the term “content element” may represent data such as text data (e.g., letters, numbers, symbols, metadata, or alt text), image data (e.g., an image, a graphic, a sequence of image frames, or a video), or audio data (e.g., a sequence of audio frames). Further, in some embodiments, a content element may be dynamic (e.g., configured to change over time), such as an animated graphic or a video advertisement. Further, in some embodiments, a content element may be interactive (e.g., configured to respond to an input from a user of a computing device), such as a button, a toggle switch, a field configured to display text, a link (e.g., a hyperlink), an icon that may be selected to launch an application, text that may be highlighted or selected (e.g., using a cursor), or one or more images that may be highlighted or selected (e.g., using a cursor). In some aspects, a content element may include one or more content elements.

In some embodiments, the document 114 may include one or more content elements that represent sensitive information. As used herein, the term “sensitive information” may refer to data that is intended for, or restricted to the use of, one or more users or entities. Sensitive information may represent data that is personal, private, confidential, privileged, secret, classified, or in need of protection. Examples of sensitive information may include financial data such as account numbers, credit card account numbers, checking account numbers, virtual card numbers, savings account numbers, account balances, credit card account balances, checking account balances, savings account balances, financial statements, bills, or invoices; personally identifiable information such as a name, address, phone number, social security number, or driver's license number; medical information such as a patient's medical history, a doctor's summary or diagnosis, or medical test results; academic information such as a student's grades or transcript; business information such as trade secrets, proprietary information, alpha product releases, or business strategy information; governmental information such as classified or secret information related to national security or defense; or data that is copyrighted, etc.

In some embodiments, the webpage 113 (or the browser module 112) may be configured to determine whether a portion, or the entirety, of the document 114 is protected by a DRM technology, where the document 114 may include one or more pages, worksheets, slides, or the like. For example, the webpage 113 may be configured to detect (e.g., using a web application) that the document 114 is associated with (e.g., represented by or includes) one or more DRM-protected videos, where the one or more DRM-protected videos are formed as HTML elements in the HTML page of the webpage 113. In some embodiments, a DRM-protected video may represent a video that includes an image frame, and that is configured to (i) play the image frame (e.g., in a loop) on a display screen when the display screen is not being screenshared or screenshotted, and (ii) not play on the display screen when the display screen is being screenshared or screenshotted. Further, in some embodiments, the document 114 may be associated with a DRM-protected video that includes an image frame depicting (or representing) sensitive information (or non-sensitive information) of the document 114. For example, where the document 114 includes one or more pages, and where one of the one or more pages includes a content element representing sensitive information (e.g., a bank account number), the document 114 may be associated with a DRM-protected video that includes an image frame depicting the content element. As another example, where the document 114 includes one or more pages, and where one of the one or more pages includes multiple content elements representing sensitive information (e.g., the user 105's address and phone number), the document 114 may be associated with multiple DRM-protected videos, each of which may include an image frame depicting a respective one of the multiple content elements. As another example, where the document 114 includes one or more pages, and where one of the one or more pages includes multiple content elements representing sensitive information (e.g., the user 105's birthday and social security number), the document 114 may be associated with a DRM-protected video that includes an image frame depicting the entire page that includes the multiple content elements. As yet another example, where the document 114 includes multiple pages, and where each of the multiple pages includes content element(s) representing sensitive information (e.g., medical information), the document 114 may be associated with multiple DRM-protected videos, each of which may include an image frame that depicts a respective page of the multiple pages.

In some embodiments, the webpage 113 (or the browser module 112) may be configured to receive, from the user 105, one or more inputs (or selections) representing one or more (or all) content elements of the document 114 that the user 105 wishes to be protected using the DRM technology. For example, where the document 114 is displayed using the display 121, the user 105 may select (e.g., by directly touching the display 121 where the display 121 is a touch screen, or by using a keyboard, mouse, trackpad, or other input device associated with the user device 110) one or more content elements (e.g., representing sensitive information or non-sensitive information) of the document 114 which the user 105 desires to be protected by the DRM technology. In response to receiving (or detecting) the selection(s), the webpage 113 (or the browser module 112) may transmit the selected one or more content elements to the application server 125 via the network 120. The webpage 113 (or the browser module 112) may further receive one or more DRM-protected videos that correspond to the selected one or more content elements from the application server 125 (e.g., via the CDM 130). In some aspects, the one or more DRM-protected videos may be configured to be overlaid on the document 114, which may be overlaid on or presented adjacent to, the webpage 113, on the display 121.

Further, in some embodiments, the webpage 113 (or the browser module 112) may be configured to determine (e.g., automatically, dynamically, in real time, or in near real time) whether the document 114 includes any content elements representing sensitive information that should protected by the DRM technology. For example, the webpage 113 (or the browser module 112) may use (and optionally include) a trained machine learning model configured to predict whether (or identify) any content elements in the document 114 include sensitive information. Where one or more contents elements of the document 114 are predicted to include sensitive information, the webpage 113 (or the browser module 112) may transmit the one or more content elements to the application server 125. Further, the webpage 113 (or the browser module 112) may receive one or more DRM-protected videos representing the transmitted one or more content elements. In some embodiments, the webpage 113 (or the browser module 112) may be configured to receive one or more DRM-protected videos representing content elements that include sensitive information of the document 114, where the application server 125 (not the webpage 113 or the browser module 112) determined that the content elements include the sensitive information.

As shown in FIG. 1, the webpage 113 may optionally include a display module 115. In some embodiments, the display module 115 may be embedded in the HTML page of the webpage 113 using, for example, an embed code or iframe. In some aspects, the display module 115 may be configured (or customized) to provide tools that allow the user 105 to view, navigate, or interact with the document 114 (which may be associated with one or more DRM-protected videos). The tools may represent interactive content elements such as a forward button (e.g., an arrow pointing a first direction), a back button (e.g., an arrow pointing in a second direction), a selectable thumbnail image (e.g., of an image frame of a DRM-protected video), or the like. Further, in some embodiments, the display module 115 may be configured (or customized) to play or present one or more DRM-protected videos associated with the document 114.

For example, where the document 114 represents a PDF file that includes two pages (e.g., a first page and a second page), the document 114 may be associated with a first DRM-protected video that includes an image frame depicting the entirety of the first page, and a second DRM-protected video that includes an image frame depicting the entirety of the second page. In some embodiments, the display module 115 may be configured to output each of the document 114 (e.g., the PDF file) and the first DRM-protected video to the display 121 (e.g., via the operating system module 116), where the first DRM-protected video may be configured to be overlaid on the document 114 (which may be configured to be overlaid on the webpage 113) on the display 121. In some other embodiments, the display module 115 may be configured to output the first DRM-protected video (but not the document 114) to the display 121 (e.g., via the operating system module 116), where the first DRM-protected video may be configured to be overlaid on the webpage 113. In some aspects, when the display 121 is not being screenshared or screenshotted, the display module 115 may cause the first DRM-protected video to play the image frame depicting the first page in a loop. The display module 115 may also cause an interactive content element, such as a forward button, to be overlaid on, or presented adjacent to, the first DRM-protected video on the display 121. Where the user 105 selects the forward button, the display module 115 may output the second DRM-protected video to the display 121 (e.g., via the operating system module 116), for display in place of the first DRM-protected video, for example. The display module 115 may further cause the second DRM-protected video to play the image frame depicting the second page in a loop on the display 121 (so long as the display 121 is not being screenshared or screenshotted). The display module 115 may also cause an interactive content element, such as a back button, to be overlaid on, or presented adjacent to, the second DRM-protected video on the display 121. Where the user 105 selects the back button, the display module 115 may output the first DRM-protected video to the display 121 (e.g., via the operating system module 116), for display in place of the second DRM-protected video, for example.

In some aspects, the display module 115 may represent an interactive (and potentially customized) video player configured to preserve the interactivity of any interactive content elements (e.g., links) depicted in an image frame of a DRM-protected video, so that the user 105 may seamlessly interact with (e.g., select) such interactive content elements. The display module 115 may also be configured to preserve any dynamic content elements (e.g., progress indicators or animations) represented in one or more image frames of one or more DRM-protected videos, so that the user 105 may view the movement or progression of such dynamic content elements in real time or near real time. In some embodiments, the display module 115 may be integrated with, configured to communicate with, or be an embodiment of, the player 118. While not shown in FIG. 1, in some embodiments, the display module 115 may be included in the browser module (e.g., as a plugin or browser extension), but not included in the webpage 113.

In some embodiments, as explained above, the browser module 112 may be configured to receive the webpage 113 from the application server 125, optionally via the CDM 130. Further, the browser module 112 may be configured to receive one or more DRM-protected videos that are associated with the webpage 113 (or the document 114), where each of the one or more DRM-protected videos may include an image frame depicting one or more content elements of the webpage 113 (or the document 114) from the application server 125 via the CDM 130. The browser module 112 may also be configured to communicate with the operating system module 116 (e.g., via a secure display path module 117). For example, the browser module 112 may be configured to transmit one or more content elements (e.g., a DRM-protected video or other data) to the operating system module 116 (e.g., via the secure display path module 117).

In some embodiments, the operating system module 116 may include one or more operating systems. In some aspects, an operating system may represent software configured to (i) manage hardware and software resources of the user device 110 or (ii) provide services for applications associated with the user device 110. In some embodiments, the operating system module 116 may include the secure display path module 117 (also referred to herein as the “secure display path 117”). In some aspects, the secure display path 117 may represent (or include) one or more DRM technologies (or DRM functions) used to protect or secure content element(s) that the secure display path 117 receives (or retrieves) from the browser module 112, the application 119, the application server 125, the application system 135, or the CDM 130. The secure display path 117 may be native (or specific) to a respective operating system of the operating system module 116. In some embodiments, the secure display path 117 may represent Microsoft's Protected Media Path, for example.

In some aspects, the secure display path module 117 may be configured to load, render, or output to the display 121, one or more content elements of a webpage (e.g., the webpage 113) or application (e.g., the application 119) for presentation, optionally while the browser module 112 or the application 119 concurrently loads, renders, or outputs to the display 121, the remainder (or a portion of) of the webpage or application for presentation. For example, where a content element of a webpage represents a DRM-protected video and includes an image frame depicting sensitive information (e.g., a checking account balance), the secure display path module 117 may load, render, or output the DRM-protected video to the display 121 while the browser module 112 concurrently loads, renders, or outputs to the display 121, the remainder (or a portion) of the webpage (e.g., a portion of the webpage that excludes the DRM-protected video and the sensitive information). In some embodiments, the DRM-protected video may be presented over background color(s) of the remainder (or a portion) of the webpage, on the display 121. As another example, where a first content element of a webpage (e.g., the webpage 113) represents a DRM-protected video that includes an image frame that is transparent (and does not depict or represent sensitive information) and where a second content element of the webpage represents sensitive information (e.g., a checking account balance), the secure display path module 117 may load, render, or output the first and second content elements to the display 121, while the browser module 112 loads, renders, or outputs to the display 121, the remainder (or a portion) of the webpage. In some aspects, the first content element (the DRM-protected video) may be presented on top of (or be overlaid on) the second content element (the sensitive information) on the display 121, which may be overlaid on the remainder (or a portion) of the webpage. Further, when the first content element (the DRM-protected video) is played on the display 121 (e.g., when the transparent image frame of the DRM-protected video is played in a loop), the user 105 may view the second content element (the sensitive information) presented under the first content element (or the transparent image frame of the DRM-protected video) on the display 121. As used herein, the terms “image frame that is transparent” and “transparent image frame” refer to an image frame of a video, where the image frame is clear (e.g., see-through or invisible, from the perspective of a user viewing the image frame on the display 121), and does not depict or represent any sensitive information.

In some aspects, the secure display path 117 may be configured to protect (or secure) one or more content elements by blocking or preventing the one or more content elements from being loaded, rendered, or output to or played on the display 121, when the display 121 is being screenshared (e.g., using a screensharing application or remote desktop application) or screenshotted (e.g., using a screenshotting application). For example, in some embodiments, the user 105 may view a DRM-protected video overlaid on a webpage on the display 121, and so long as the display 121 is not screenshared or screenshotted, the DRM-protected video may be played on the display 121. While the DRM-protected video is played, the user 105 may be able to see a content element (e.g., a credit card balance) that is either (i) represented in an image frame of the DRM-protected video or (ii) presented under a transparent image frame of the DRM-protected video. However, if the user 105 attempts to screenshare or take a screenshot of the display 121 with a social engineer (or potential social engineer), the secure display path 117 may cause the DRM-protected video to stop playing (or be blocked from playing) so that the social engineer (or potential social engineer) and the user 105 cannot see the content element. In some aspects, the secure display path 117 or the DRM technology of the DRM-protected video may use hardware-based security functionality of the user device 110 to secure the DRM-protected video.

The application 119 may be an application, program, web application, portal, platform, or platform interface installed on the user device 110 and optionally downloaded from the application server 125 or the application system 135, via the network 120. In some embodiments, the application 119 may be an embodiment of the webpage 113. Further, the application 119 may be configured to communicate with the browser module 112, the operating system module 116 (e.g., the secure display path module 117), the player 118, the display 121, the application server 125, the application system 135, and the CDM 130. In some embodiments, one or more of the application 119, an application associated with the application 119, the browser module 112, the application server 125, or the application system 135, may be configured to authenticate a user (e.g., the user 105) viewing (or accessing) the application 119 using, for example, Single Sign-On (“SSO”), multi-factor authentication (“MFA”), or the like. In some embodiments, the application 119 may include or be associated with the document 114 (or multiple documents 114) and the display module 115. The document 114 and the display module 115 may be configured as described above with reference to the webpage 113, or in a similar manner.

The application system 135 may include a server or other computing device, and may be configured to interact with other systems, such as the user device 110, the application server 125, or the CDM 130, in the environment 100. For example, in some embodiments, the application system 135 maybe configured to receive, store, or transmit to the user device 110, one or more webpages (e.g., the webpage 113), websites, web applications, portals, platforms, applications (e.g., the application 119), programs, browser extensions, plugins, or the like.

The application server 125 may be a computing system such as a server, a workstation, a desktop computer, a laptop, a mobile device, a tablet, etc. In some examples, the application server 125 may be associated with (or include) a cloud computing platform with scalable resources for computation or data storage. The application server 125 may run one or more applications locally or using the cloud computing platform, to perform various computer-implemented methods described in this disclosure. In some embodiments, the application server 125 may be associated with (e.g., owned, rented, or controlled by) a company, a business, or an organization, such as a law firm, bank, a hospital, a university, or a merchant, etc.

In some aspects, the application server 125 may be configured to communicate with the user device 110, the application system 135, and the CDM 130, via the network 120. For example, the application server 125 may be configured to transmit an HTML page (or file) corresponding to the webpage 113 to the browser module 112, the operating system module 116, or the application 119, via the network 120. In some embodiments, the application server 125 may be configured to receive a notification (or determination) from the browser module 112 that one or more content elements of the HTML page corresponding to the webpage 113 (or one or more content elements of the document 114) include sensitive information. Further, in some embodiments, the application server 125 may be configured to determine whether one or more content elements of the HTML page of the webpage 113 (or one or more content elements of the document 114) include sensitive information. In response to determining (or receiving a determination) that a content element includes sensitive information, the application server 125 may dynamically generate and encrypt a DRM-protected video that includes either (i) a transparent image frame configured to be presented over the sensitive information on the display 121 or (ii) an image frame that depicts or represents the sensitive information. In some embodiments, the application server 125 may convert the content element into such an encrypted, DRM-protected video. In some aspects, the application server 125 may be configured to transmit the encrypted, DRM-protected video to the CDM 130 (which may decrypt the encrypted DRM-protected video and transmit the decrypted DRM-protected video to the user device 110).

In some aspects, the CDM 130 (or DRM platform 130) may be configured to communicate with the user device 110, the application system 135, and the application server 125, via the network 120. For example, the CDM 130 may be configured to receive an encrypted, DRM-protected video from the application server 125 (or elsewhere on the network 120). The CDM 130 may also be configured to decrypt the encrypted, DRM-protected video, and transmit the decrypted, DRM-protected video to the user device 110 (e.g., to the browser module 112, the operating system module 116, or the application 119).

In various embodiments, the network 120 may be a wide area network (“WAN”), a local area network (“LAN”), personal area network (“PAN”), or the like. In some embodiments, network 120 may include the Internet, and support the transmission of information and data between various systems online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page,” “website,” or “webpage” generally encompasses a location, data store, or the like that is, for example, hosted or operated by a computer system so as to be accessible online, and that may include data configured to cause a program such as a browser to perform operations such as send, receive, or process data, generate a visual display or an interactive interface, or the like

Although depicted as separate components in FIG. 1, it should be understood that a component or portion of a component in the environment 100 may, in some embodiments, be integrated with or incorporated into one or more other components. For example, in some embodiments, at least a portion of the application server 125, the application system 135, or the CDM 130 may be integrated into the user device 110. In some embodiments, operations or aspects of one or more of the components discussed above may be distributed amongst one or more other components. Any suitable arrangement or integration of the various systems and devices of the environment 100 may be used. Further, in some embodiments, the environment 100 may include multiple user devices 110, multiple application systems 135, multiple application servers 125, or multiple CDMs 130.

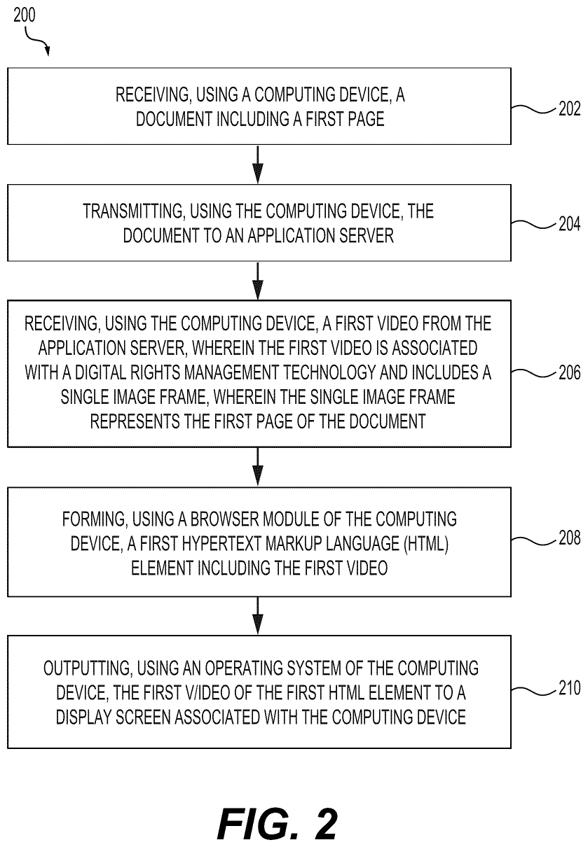

FIG. 2 is a flowchart illustrating a method 200 for securing content of a document (e.g., a text document, an image document, a presentation, a spreadsheet, a PDF file, a multimedia file, or the like), according to one or more embodiments of the present disclosure. In some aspects, the method 200 may be performed by a computing device (e.g., the user device 110).

As shown in FIG. 2, the method 200 may include receiving, using a computing device (e.g., the user device 110, the browser module 112, the operating system module 116, or the application 119), a document (e.g., the document 114) including a first page (202). In some embodiments, the document may be included in, or associated with, an HTML page of a portal (e.g., the webpage 113 or the application 119). In some embodiments, the document may represent one of a text document, an image document, a presentation, a spreadsheet, a PDF file, or a multimedia file. Further, in some embodiments, the first page may include sensitive information. In some embodiments, the method 200 may include, prior to receiving the document, authenticating, using the computing device, a user (e.g., the user 105) associated with the computing device, where the authentication is associated with the portal.

The method 200 may include transmitting, using the computing device, the document to an application server (e.g., the application server 125) (204). The method 200 may further include receiving, using the computing device, a first video from the application server, where the first video is associated with a DRM technology and includes a single image frame, where the single image frame represents the first page of the document (206). In some embodiments, the first video may be configured to play the single image frame in a loop on a display screen associated with the computing device (e.g., the display 121) when the display screen is not being screenshared or screenshotted. The first video may also be configured to not play on the display screen when the display screen is being screenshared or screenshotted.

The method 200 may include forming, using a browser module (e.g., the browser module 112) of the computing device, a first HTML element including the first video (208). The method 200 may also include outputting, using an operating system (e.g., the operating system module 116) of the computing device, the first video of the first HTML element to the display screen associated with the computing device (210). In some embodiments, the method 200 may further include outputting, using the computing device, the portal to the display screen, where the outputted video is configured to be overlaid on the portal on the display screen. In some embodiments, the outputted video may be configured to be overlaid on the document on the display screen, and the document may be configured to be overlaid on the portal (e.g., a background color of the portal) on the display screen.

In some embodiments, the method 200 may further include receiving, using the computing device, a second video from the application server, where the second video is associated with the DRM technology and includes a single image frame, and where the single image frame represents a second page of the document. The method 200 may include forming, using the browser module of the computing device, a second HTML element including the second video. The method 200 may also include outputting, using the operating system of the computing device, the second video of the second HTML element to the display screen. In some embodiments, the first video and the second video may be configured to be presented on the display screen (e.g., sequentially) using a display module (e.g., the display module 115).

In general, any process or operation discussed in this disclosure that is understood to be computer-implementable, such as the processes (or methods) illustrated in FIG. 2, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

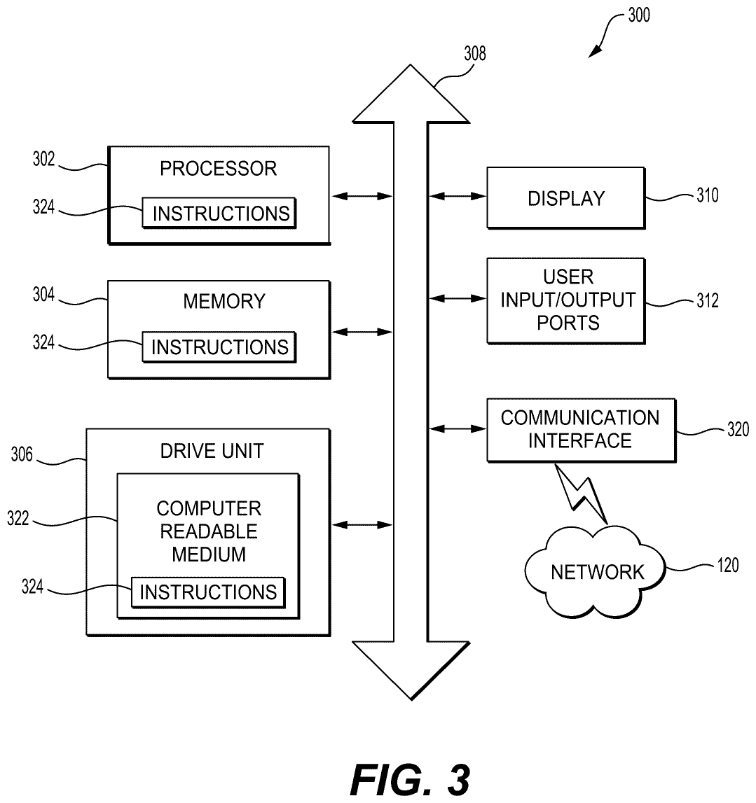

FIG. 3 is a simplified functional block diagram of a computer 300 that may be configured as a device for executing the methods of FIG. 2, according to exemplary embodiments of the present disclosure. For example, in some embodiments, the computer 300 may be configured as the user device 110, according to exemplary embodiments of this disclosure. In some other embodiments, the computer 300 may be configured as the application server 125, according to exemplary embodiments of this disclosure. In some other embodiments, the computer 300 may be configured as the application system 135, according to exemplary embodiments of this disclosure. In some other embodiments, the computer 300 may be configured as the CDM 130, according to exemplary embodiments of this disclosure. In various embodiments, any of the devices or systems herein may be a computer 300 including, for example, a data communication interface 320 for packet data communication. The computer 300 also may include a central processing unit (“CPU”) 302, in the form of one or more processors, for executing program instructions. The computer 300 may include an internal communication bus 308, and a storage (or drive) unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 or computer readable medium 322). The computer 300 also may include input and output ports 312 or a display (or display screen) 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method comprising:
receiving, using a computing device, a document including a first page;
transmitting, using the computing device, the document to an application server;
receiving, using the computing device, a first video from the application server, wherein the first video is associated with a digital rights management technology and includes a single image frame, wherein the single image frame represents the first page of the document;
forming, using a browser module of the computing device, a first Hypertext Markup Language (HTML) element including the first video; and
outputting, using an operating system of the computing device, the first video of the first HTML element to a display screen associated with the computing device.

2. The method of claim 1, wherein the document represents one of:
a text document;
an image document;
a presentation;
a spreadsheet;
a Portable Document Format (PDF) file; or
a multimedia file.

3. The method of claim 1, wherein the first page includes sensitive information.

4. The method of claim 1, further comprising:
outputting, using the computing device, a portal to the display screen, wherein the outputted first video is configured to be overlaid on the portal on the display screen.

5. The method of claim 4, wherein the portal represents a webpage or an application associated with the computing device.

6. The method of claim 4, further comprising:
authenticating, using the computing device and prior to receiving the document, a user associated with the computing device, wherein the authentication is associated with the portal.

7. The method of claim 1, wherein the document further includes a second page, the method further comprising:
receiving, using the computing device, a second video from the application server, wherein the second video is associated with the digital rights management technology and includes a single image frame, wherein the single image frame represents the second page of the document;
forming, using the browser module of the computing device, a second HTML element including the second video; and
outputting, using the operating system of the computing device, the second video of the second HTML element to the display screen.

8. The method of claim 7, wherein the first video and the second video are configured to be presented on the display screen using a display module.

9. The method of claim 1, wherein the first video is configured to play on the display screen when the display screen is not being screenshared or screenshotted.

10. The method of claim 1, wherein the first video is configured to not play on the display screen when the display screen is being screenshared or screenshotted.

11. The method of claim 1, wherein the first video is configured to play the single image frame in a loop.

12. A system comprising:
at least one processor; and
at least one memory having programming instructions stored thereon, which, when executed by the at least one processor, cause the system to perform operations comprising:
receiving, using a computing device, a document including a first page;
transmitting, using the computing device, the document to an application server;
receiving, using the computing device, a first video from the application server, wherein the first video is associated with a digital rights management technology and includes a single image frame, wherein the single image frame represents the first page of the document;
forming, using the computing device, a Hypertext Markup Language (HTML) element including the first video; and
outputting, using the computing device, the first video of the HTML element to a display screen associated with the computing device.

13. The system of claim 12, wherein the document represents one of:
a text document;
an image document;
a presentation;
a spreadsheet;
a Portable Document Format (PDF) file; or
a multimedia file.

14. The system of claim 12, wherein the first page includes sensitive information.

15. The system of claim 12, further comprising:
outputting, using the computing device, a portal to the display screen, wherein the outputted first video is configured to be overlaid on the portal on the display screen.

16. The system of claim 15, wherein the portal represents a webpage or an application associated with the computing device.

17. The system of claim 15, wherein the operations further include:
authenticating, using the computing device and prior to receiving the document, a user associated with the computing device, wherein the authentication is associated with the portal.

18. The system of claim 12, wherein the document further includes a second page, the operations further comprising:
receiving, using the computing device, a second video from the application server, wherein the second video is associated with the digital rights management technology and includes a single image frame, wherein the single image frame represents the second page of the document;
forming, using the computing device, a second HTML element including the second video; and
outputting, using the computing device, the second video of the second HTML element to the display screen.

19. The system of claim 12, wherein the first video is configured to play on the display screen when the display screen is not being screenshared or screenshotted.

20. A method comprising:
receiving, using a computing device, a document including a page, wherein the page includes sensitive information;
transmitting, using the computing device, the document to an application server;
receiving, using the computing device, a video from the application server, wherein the video is associated with a digital rights management technology and includes a single image frame, wherein the single image frame represents the page of the document;
forming, using a browser module of the computing device, a Hypertext Markup Language (HTML) element including the video; and
outputting, using an operating system of the computing device, the video of the HTML element to a display screen associated with the computing device.
